(19) United States
(12) Patent Application Publication
(10) Pub. No.: US 2008/0208712 A1
(43) Pub. Date: Aug. 28, 2008

(54) Computer based systems to conduct sales of products or services over a communication network

(76) Inventors: Phil Yerkes, Seattle, WA (US); Stanley Wang, Seattle, WA (US); John Calian, Seattle, WA (US)

Correspondence Address: HELLER EHRMAN LLP, 4350 La Jolla Village Drive, 7th Floor, San Diego, CA, 92122, US

(21) Appl. No.: 11/680,395

(22) Filed: Feb. 28, 2007

(51) Int. Cl. G06Q 30/00

(52) U.S. Cl. 705/27

(57) ABSTRACT

A computer based system is provided for sales of a product or service. A gateway system is provided that has a database with one or more catalogs of content for products or services: A merchant interface, for a merchant, is coupled to the gateway system. A buyer interface, for a buyer, is coupled to the merchant interface and the gateway system. The gateway system hosts the purchase of products or services by a buyer in a manner such that purchase of products or services, by the buyer, appears as a purchase through the merchant interface and not through the gateway system.

### BACKGROUND OF THE INVENTION

1. Field of the Invention

The present invention relates to electronic commerce, and more specifically, to a system for providing a catalog of content from a gateway system to a merchant interface in a manner to make the purchase of the product or service by a buyer, through merchant interface, transparent to the buyer.

2. Description of the Related Art

Over the last several years, the Internet has seen expansive growth in the area of electronic commerce (“e-commerce”). Today, many consumers shop over the Internet from electronic retailers (“merchants”) in the privacy of their home instead of shopping from catalogs or physically going to a store. While a consumer may not be able to physically handle the products while shopping on the Internet, the consumer may be able to view pictures of the products, have textual, graphical and audio descriptions of the products, as well as read reviews of the products. For example, a merchant may create an e-commerce site on the World Wide Web (the “Web” or “WWW”) that is devoted to products carried in a physical store. This product information is typically made accessible to a consumer over the Internet through interfaces created by the merchant. A problem with this approach is that consumers have to learn how to navigate through all of the different e-commerce sites where they are interested in shopping. It would therefore be desirable to have an e-commerce site where the consumer navigates in the same manner whether shopping from Merchant A or Merchant B.

Typically, merchants provide the consumer with a search engine to find products on their Web site. While this makes navigation somewhat easier than the consumer manually navigating through each interface, there are still problems. For example, each merchant may use a different search engine having different input requirements and/or the merchant may return matches to the search made by the consumer in a different manner. What is needed is a consistent manner of inputting and returning matches to the consumer.

If the consumer locates a product in which he or she is interested, the consumer is typically allowed to purchase the product(s) at that time. For example, if the consumer is interested in purchasing Product A from the merchant, the consumer will provide appropriate information to the merchant over a secure connection in order to process the order. This information typically includes name, shipping address, billing address, payment information and desired shipping method. This information is typically entered through an input form on a interface designed and provided by the merchant. It is also common for the merchant to require the consumer to create an account on the merchant's site before purchasing products. If a consumer purchases items from many different sites he or she will have to keep track of many different accounts. It is desirable, therefore, to have a shopping site that enables a consumer to order products from many different merchants without requiring the consumer to keep track of all the different accounts required to purchase goods from the many different merchants.

Another e-commerce problem is that it is becoming harder for a consumer to locate products and comparison shop over the Internet. This is due to the sheer volume of merchants, products and services available to the consumer over the Internet. Today, a consumer may also use one of the commonly available search engines on the Internet to locate products. However, search engines generally return so many matches to a query that it is unrealistic for a consumer to manually inquire on each returned match. In addition, these matches also include both merchant and non-merchant Web sites making it even more difficult for a consumer to actually review all of the returned merchant sites. Further, either the Web shopping sites direct the consumer to another merchant Web site, or they place the merchant's Web site within a frame on one of their main pages. However, this approach does not provide the consumer with a consistent look and feel.

In an attempt to solve the above-mentioned problems of comparison shopping and locating products on the Internet, many different methods have been created that provide the consumer with access to many different merchant sites through one central site. For example, U.S. Pat. No. 5,895,454 to Harrington purports to describe a shopping system allowing the consumer to connect to remote Web sites whereupon the consumer interacts with the remote merchant Web site using the commands and structure hierarchy as originally established by the merchant. As the consumer navigates through the remote merchant's Web site, the consumer may return to the database interface to launch into a different remote merchant Web site.

The problem with this approach is that the consumer still has to learn how to navigate and place orders through many different merchants. For example, if a consumer desires to purchase a product from Merchant A and Merchant B, the consumer will have to navigate each merchant's site. Today, either the Web shopping sites direct the consumer to another merchant Web site, or they place the merchant's Web site within a frame on one of their main pages. A problem with this approach is that the consumer does not have a consistent look and feel. What is needed is a shopping site that provides a uniform ordering and navigation from multiple merchants.

As e-commerce has developed, the term “shopping basket” or “shopping cart” has become commonly known on the Internet to refer to a virtual shopping cart where the consumer stores the products and/or services he/she is interested in purchasing while browsing a particular merchants Web site. A shopping cart typically allows a consumer to add or delete products, specify attributes, such as color, quantity, size, and the like, and purchase products contained within the cart. Once the consumer has completed his/her selections of the products he or she is interested in purchasing, the consumer typically clicks on a link on one of the merchant's interfaces to purchase the contents of the shopping basket. A problem with the shopping carts, however, is that they are specific to each merchant. Another problem is that the shopping carts do not allow a consumer to keep products from different merchants not purchased in their shopping cart from one visit to the next shopping site. It would be desirable, therefore, to have a shopping cart that would maintain the items in the cart persistently until the consumer decides to delete the product or purchase the product.

Another problem is that the shopping site may “lose” the consumer after the consumer becomes interested in a product. For example, assume the shopping site returned two products from two different merchants based on the consumer's criteria. If the consumer clicks on the link for the first product the shopping site may either direct the consumer to Merchant A or may provide the merchant's site within a frame of the shopping site. Nevertheless, the consumer at this point is able to go directly to the merchant's site and bypass the shopping site when purchasing the products.

There is a need for methods and computer based systems, to conduct the sale of a product or service over a communication network, that permits buyers to purchase products or services through a gateway system, where the purchase appears to the buyer to be through a merchant associated with the gateway system and not through the gateway system. There is another need for methods and computer based systems to sell digital content, more particularly digital content for mobile devices, with reduced back end interaction work. There is a further need for methods and computer based systems for the sale of mobile content that does not require the approval/qualification of carriers of the mobile content for each merchant that sells the mobile content. Yet there is a further need for methods and computer based systems for the sale of mobile content through a gateway system, and merchants associated with the gateway system, that requires the approval of the carriers only for the gateway system and not approvals for the merchants. There is a further need for methods and computer based systems for the sale of mobile content that enable merchants to sell the mobile content without having a direct relationship with the carriers of the mobile content.

### SUMMARY OF THE INVENTION

Accordingly, an object of the present invention is to provide computer based systems to conduct the sale of a product or service over a communication network, that permits buyers to purchase products or services through a gateway system, where the purchase appears to the buyer to be through a merchant associated with the gateway system and not through the gateway system.

Another object of the present invention is to provide computer based systems to sell digital content, more particularly digital content for mobile devices, with reduced back end interaction work.

A further object of the present invention is to provide computer based systems for the sale of mobile content that does not require the approval/qualification of carriers of the mobile device for each merchant that sells the mobile content.

Still a further object of the present invention is to provide computer based systems for the sale of mobile content through a gateway system, and merchants associated with the gateway system, that requires the approval of the carriers only for the gateway system and not approvals for the merchants.

Another object of the present invention is to provide computer based systems for the sale of mobile content that enable merchants to sell the mobile content without having a direct relationship with the carriers of the mobile device.

These and other objects of the present invention can be achieved in a computer based system sales of a product or service. A gateway system is provided that has a database with one or more catalogs of content for products or services: A merchant interface, for a merchant, is coupled to the gateway system. A buyer interface, for a buyer, is coupled to the merchant interface and the gateway system. The gateway system hosts the purchase of products or services by a buyer in a manner such that purchase of products or services, by the buyer, appears as a purchase through the merchant interface and not through the gateway system.

### BRIEF DESCRIPTION OF THE FIGURES

FIG. 1(a) is a schematic diagram illustrating one embodiment of a computer-based system of the present invention that includes a gateway system, merchant interface and a buyer interface.

FIG. 1(b) is a schematic diagram illustrating one embodiment of a gateway system of the present invention.

FIG. 2 is a flow chart illustrating one embodiment of the arrival of a purchase request at the gateway system, where the first step is to render a customized checkout page.

FIG. 3 is a flow chart illustrating one embodiment of payment methods available for use by buyers from a per seller configuration that is stored in a database.

FIG. 4 is a flow chart illustrating one embodiment of the present invention illustrating that a seller can configure purchase options with an administration tool of the gateway system.

FIG. 5 is a flow chart illustrating one embodiment of the present invention showing that the merchant can use the administration tool of the gateway system to make the gateway system interface appear to be like or similar to the merchant's interface

FIG. 6 is a flow chart illustrating one embodiment of the present invention showing product or service information is rendered on the gateway system checkout page.

FIG. 7 is a flow chart illustrating one embodiment of the present invention showing that the gateway system can determine whether to display carrier and device selection as part of the buyer's inputs based on the system configuration.

FIG. 8 is a flow chart illustrating one embodiment of how user inputs are validated.

FIG. 9 is a flow chart illustrating one embodiment of the present invention of a checkout process that includes the order placing process and the order entering process.

FIG. 10 is a flow chart illustrating one embodiment of the present invention showing the gateway system with multiple purchase options and how the order placing with the login process can be executed.

FIG. 11 is a flow chart illustrating one embodiment of the present invention showing order placing login by a buyer.

FIG. 12 is a flow chart illustrating one embodiment of the present invention showing an order entering process.

FIG. 13 is a flow chart illustrating on embodiment of the present invention showing a subscriber order entering process

FIG. 14 is a flow chart illustrating one embodiment of the present invention showing a subscriber order entering process.

FIG. 15 is a flow chart illustrating one embodiment of the present invention showing an order confirmation process.

FIGS. 16(a) through 16(e) illustrate one embodiment of the present invention showing the order processing system, with different types of message.

FIG. 17 is a flow chart illustrating one embodiment of the present invention showing a message system.

FIG. 18 is a flow chart illustrating one embodiment of the present invention showing order processing.

FIG. 19 is a flow chart illustrating one embodiment of the present invention showing a message watcher.

FIG. 20 is a flow chart illustrating one embodiment of the present invention showing a message dispatcher.

FIG. 21 is a flow chart illustrating one embodiment of the present invention showing a message listener.

FIG. 22 is a flow chart illustrating one embodiment of the present invention showing a message processor.

FIG. 23 is a flow chart illustrating one embodiment of the present invention showing a process state indication for an incoming message.

FIG. 24 is a flow chart illustrating one embodiment of the present invention showing processing of a mobile originated message.

FIG. 25 is a flow chart illustrating one embodiment of the present invention showing a message cleaner.

FIG. 26 is a flow chart illustrating one embodiment of the present invention showing a content delivery system with a buyer's mobile device.

FIG. 27 is a flow chart illustrating one embodiment of a content delivery system with a buyer's mobile device of the present invention.

### DETAILED DESCRIPTION OF THE PREFERRED EMBODIMENT

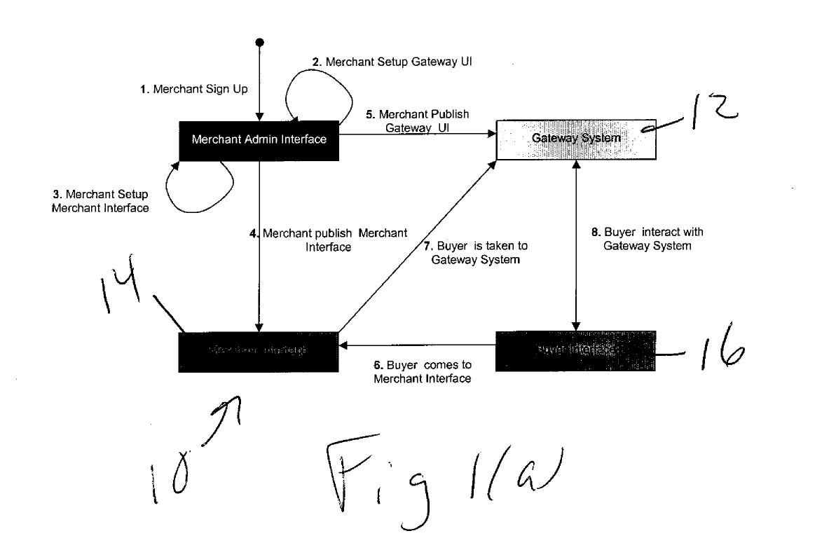

Referring to FIGS. 1(a) and 1(b), in one embodiment of the present invention, a computer-based method and system includes 10 a gateway system 12 that has a database with a catalog of content relative to products or services. The gateway system 12 includes a content delivery system, a checkout system and an order processing and messaging system. The gateway system 12 is a checkout page for multiple merchants.

The content can include, product identification number, product name, product producer, product vendor, identification number, product cost, product size (in bits of data), product digital file format and the like. In one specific embodiment, the product or service is digital content. In another embodiment, the content is mobile content. The mobile content can be software that runs on a mobile or handheld device. In one embodiment, the mobile content includes at least one of, ring tone music, full track music, streaming music, polyphonic version of music, video games, video clips, streaming video, full video tracks, video clip which can be rendered via flash light, digital artwork which can be rendered via flash light. digital artwork in any format, including but not limited to artwork in PNG, JPG, GIF, TIFF; java based applications, BREW based applications, and the like.

A merchant interface 14, for a merchant, is coupled to the gateway system 12. The merchant interface 14 is editable, and selects individual or multi pieces of the content to add to the merchant interface 14. Examples of suitable merchant interfaces 14 include but are not limited to, an html page, a web page, a hyperlink, a portion of the HTML code, an XHTML page and the like.

A buyer interface 16, for a buyer, is coupled to the merchant interface 14. The catalog of content can be added to the merchant interface 14 in a manner to make the purchase of the product or service by a buyer transparent to the buyer. In one embodiment, the buyer interface 16 is selected from at least one of, a mobile device, a computer and the like. Examples of suitable mobile devices include but are not limited to, a PDA, smart phone, cell phone, mp3 player, anything that can be coupled to the internet, and the like.

Messages are sent to the gateway system 12 through the buyer's mobile device. The gateway system 12 can send SMS notification to the buyer, on behalf of a merchant, for content downloads. and handles message interactions between buyers and merchants. The gateway system 12 is configured to provide billing integration.

The gateway system 12 is configured to provide that for a purchase of a product or service by a buyer, the buyer selects content from the one or more catalogs of content. The gateway system 12 hosts the purchase of products or services by a buyer accessing the merchant interface 14, and receives buyer's orders for the product or service. The gateway system 12 enables the catalogs of content to be added to the merchant interface 14 in a manner such that purchase of products or services by a buyer appears as a purchase through the merchant interface 14 and not through the gateway system 12 The gateway system 12 provides billing integration.

The system of the present invention provides a sign up mechanism that allows merchants to enter into an arrangement with the gateway system 12 to offer products and services for sale through the merchant interface 14. These products and services are cataloged on the gateway system 12. Merchants enter into business relationships with the gateway system 12 for the sale of the products and services. Each merchant establishes an account with the gateway system 12.

The system of the present invention provides a purchase mechanism that allows a buyer to view, at the merchant's interface, what products or services, from the gateway system 12, are being offered for sale by the merchant and to place an order through the gateway system 12 via the merchant's interface. In response to a buyer's request for a product and service through the merchant interface 14, the buyer's interface is directed, by the gateway system 12 to display an user interface hosted by the system. This aspect of hosting an user interface is also totally transparent to the buyer and after the buyer selects and/or chooses all required inputs on said user interface the buyer is transparently redirected back to the merchant's interface, including but not limited to a Web site.

To purchase a product, a buyer views an interface provided by the gateway service. The interface may show a graphical image of various products. Each image can have a URL associated with it that is a link to an interface provided by the Web site of the merchant of the product. If a buyer wishes to find more information about a product or service, or to purchase the product, the buyer can simply selects the image of the product displayed. When the image is selected, the buyer computer then requests access to the gateway system 12 through the merchant's identified by the associated URL. The gateway system 12 provides the merchant interface 14 to the buyer computer. Once the buyer computer receives the merchant interface 14, it displays the interface to the buyer. Using the merchant interface 14, the buyer can view additional information about the product and purchase the product. After the order is placed, the merchant interface 14 directs the buyer computer to redisplay a interface of the gateway system 12 transparent to the buyer. The buyer only sees the merchant interface 14. Involvement of the gateway system 12 in the purchase of products or services by the buyer is transparent to the buyer and appears as a purchase through the merchant interface 14.

In one embodiment, merchants are able to include and couple their own merchant content with the content selected from catalogs of content from the gateway system 12.

The gateway system 12 enables customization of a graphical user interface hosted by the gateway system 12. By way of illustration, and without limitation, the gateway system 12 enables customization of a graphical user interface hosted at the merchant interface 14. Merchants can customize terms and conditions of sale for products or services through the merchant interface 14. Merchants can customize order confirmation e-mails through the merchant interface 14 for products and services hosted by the gateway system 12.

The merchant interface 14 can include a system administration interface configured to perform at least one of, configure gateway user interface, view reports, select an individual product to merchandise or select a catalog of content to merchandise, select product meta-data to display (descriptions, reviews, screen shots), select product billing options (one-time, subscription, try-before-you buy), select billing mechanisms (bill-to-phone aka carrier billing, credit-card, Paypal, Google checkout, bill-me-later), configure its administrative capabilities within its account, and the like.

In one embodiment, the merchant interface 14 is configured to provide at least one of, customization of a hosted check out, an order confirmation page, and the like.

The merchant interface 14 can include a hosted check out page. The gateway system 12 has a buyer checkout page. The merchant interface 14 can include a hosted check out page.

The merchant interface 14 can provide for customization of a hosted check out, or of an order confirmation page. In response to a selection of content by a buyer from the catalogs of content, a check out page and/or order confirmation page can be customizable by a merchant. Merchants can customize headers and footers, terms and conditions of sale, advertisements, web page color, web page design, web page display, web page background color, web page font size, web page background image, multi-media on a web page, and the like.

In one embodiment, the gateway system 12 is configured to determine whether to display carrier and device selection in response to inputs by the buyer. In another embodiment, the gateway system 12 automatically determines a buyer's carrier.

The gateway system 12 is configured to validate selected user inputs and permits the buyer to use its form to purchase products or services all of which are tied to the merchant

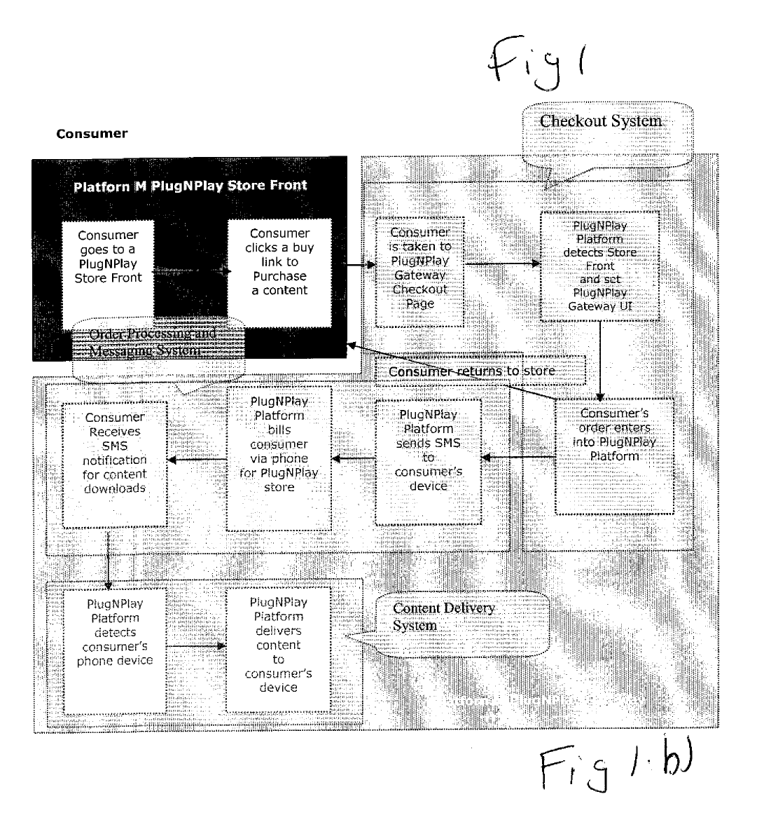

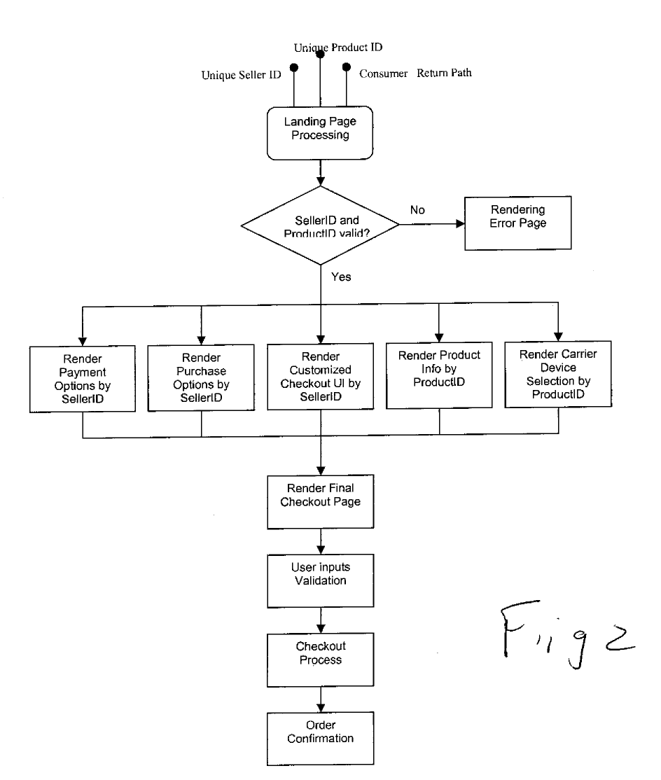

The checkout system includes customized checkout page rendering, user input validation, checkout processing, checkout confirmation and the like. As illustrated in FIG. 2, when a purchase request arrives at the gateway system 12, the first step is to render a customized checkout page is provided that is based on a unique seller identifier which is included in a purchase request. Sellers of products or services can configure their payment methods in different methods. These payment methods are then available for use by the buyers from a per seller configuration that is stored in a database as illustrated in FIG. 3.

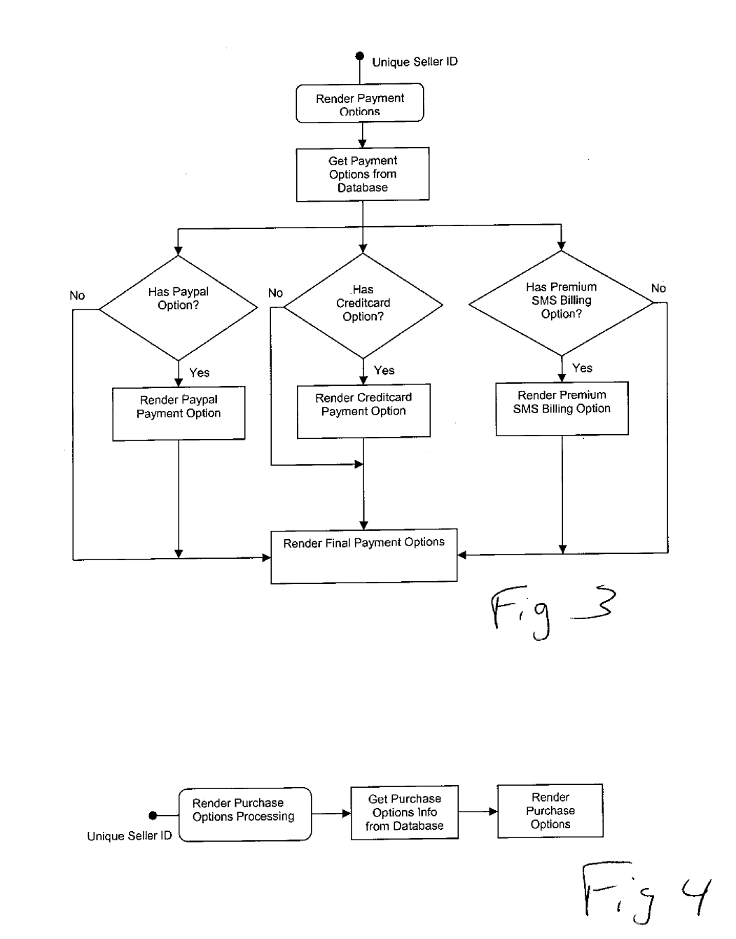

Referring now to FIG. 4, a seller can also configure purchase options with an administration tool of the gateway system 12. These purchase options are rendered from a per seller configuration that is can includes price, credits, service period and the like.

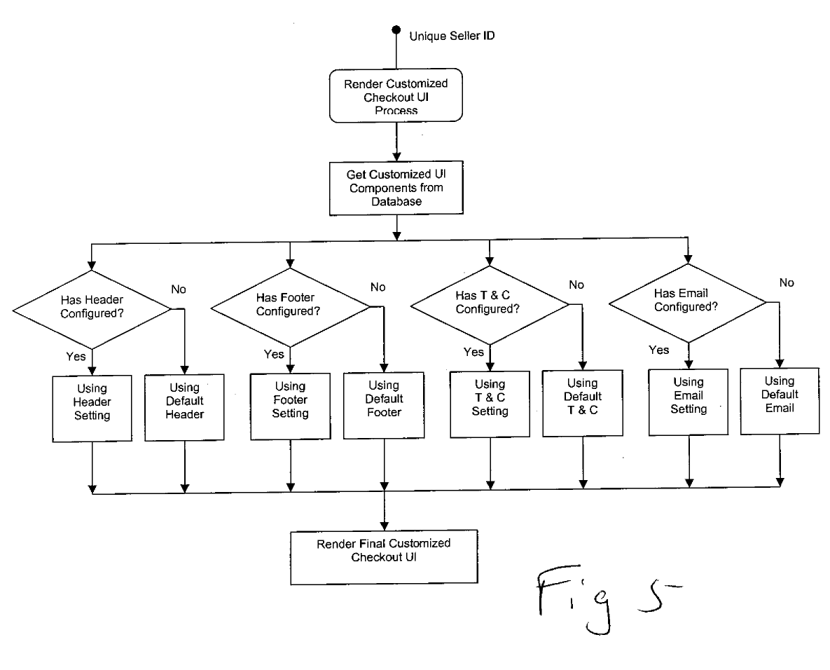

The merchant can use the administration tool of the gateway system 12, as shown in FIG. 5, to make the gateway system 12 interface appear to be like or similar to the merchant's interface. The components that can be customized include but are not limited to, page header, page footer, terms and conditions, order confirmation e-mail, and the like.

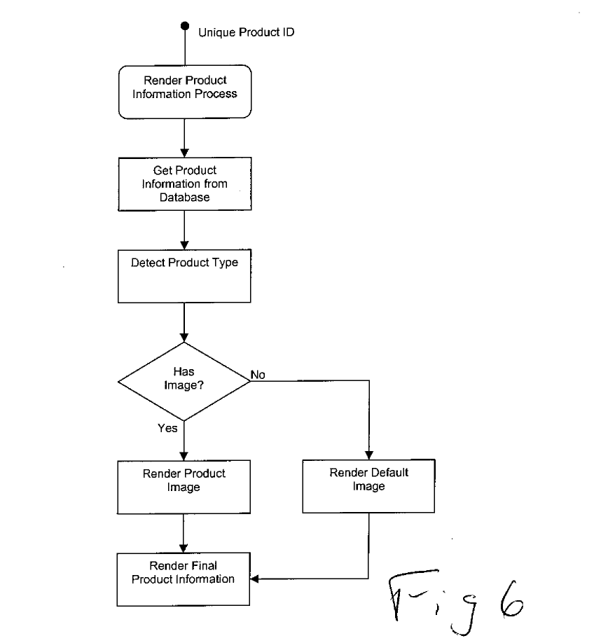

Referring now to FIG. 6, product or service information, relative to a product or service selected by a buyer, is rendered on the gateway system 12 checkout page. The checkout page can include the product name, artist name, product type, product purchase price, product image, and the like.

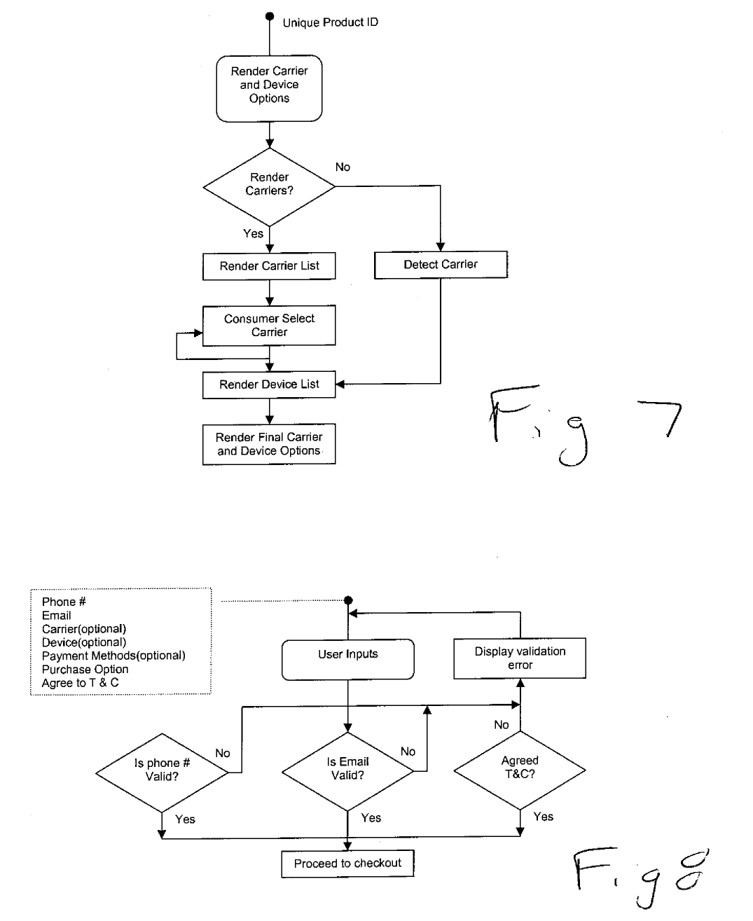

Referring to FIG. 7, in one embodiment, the gateway system 12 determines whether to display carrier and device selection as part of the buyer's inputs based on the system configuration. If there is no carrier selection displayed on the checkout page, the gateway system 12 detects the buyer's carrier. The gateway system 12 is able to determine whether it display device selection as part of consumer inputs based on system configuration and a unique product identifier. When the gateway system 12 is configured to display device selection, then the list of devices is based on the carrier selected. The gateway system 12 is configured to permit a variety of buyer inputs including but not limited to, buyer mobile device number, buyer mobile device make, buyer mobile device model, buyer mobile device wireless carrier, buyer email, buyer acceptance of terms and conditions, buyer choice of purchase price, buyer choice of payment option, buyer choice of product purchase and the like.

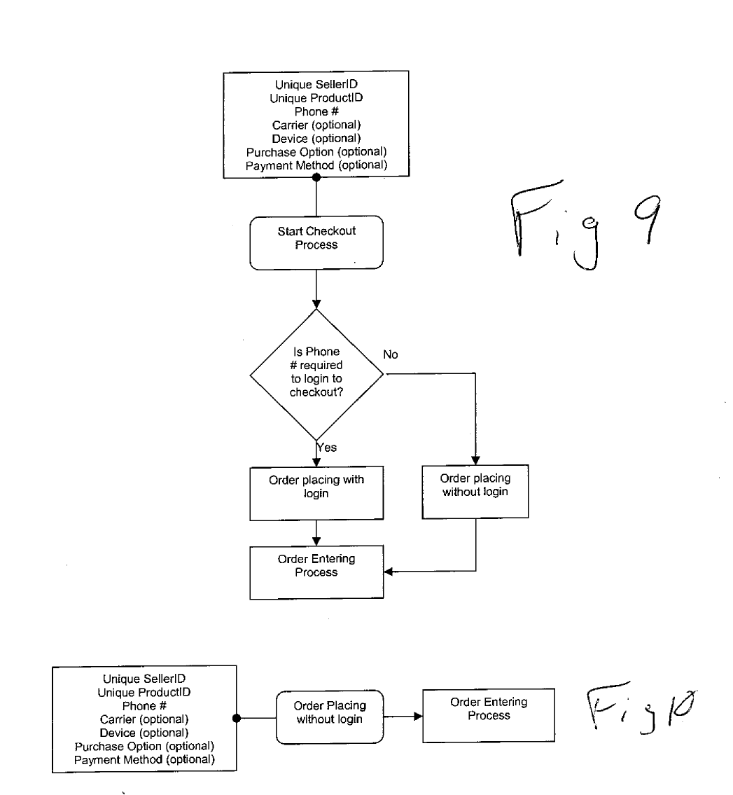

FIG. 8, illustrates how user inputs are validated.

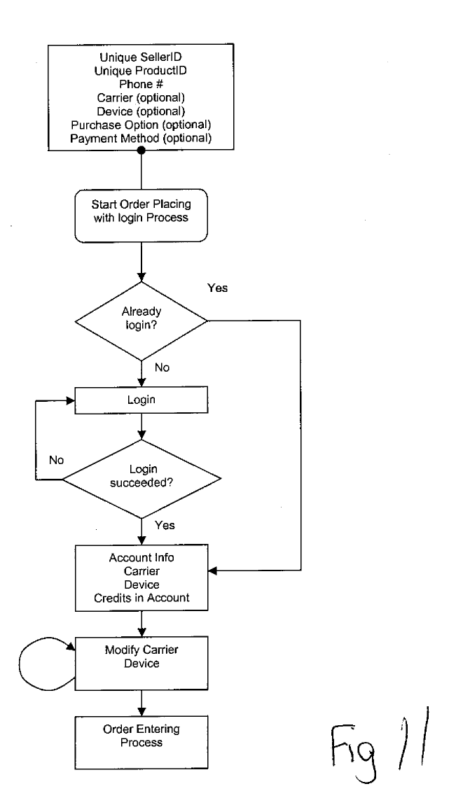

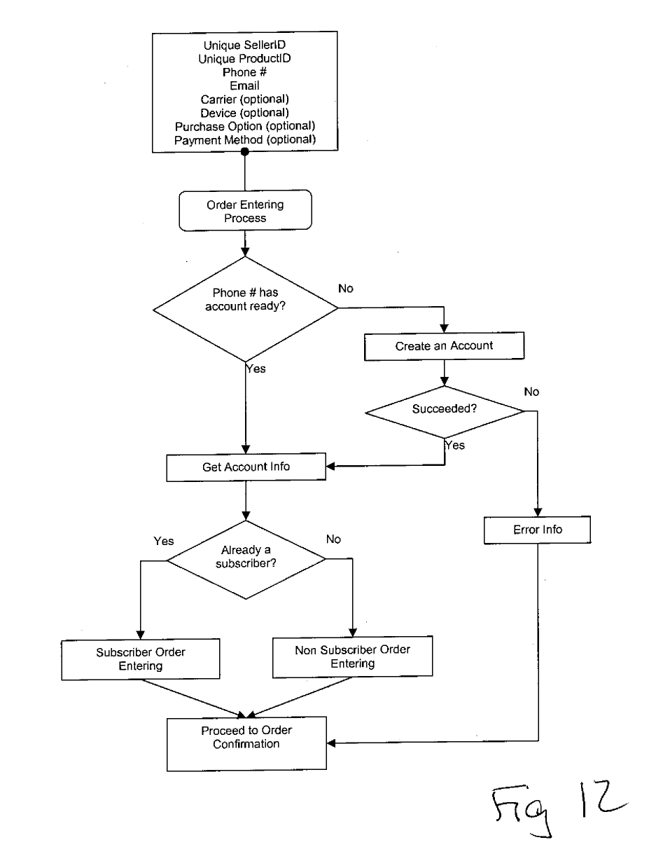

The checkout process, shown in FIG. 9, includes the order placing process and the order entering process. The order placing process can include, order placing without login and order placing with login. If the gateway system 12 is configured to have multiple purchase options, then order placing with login process can be executed, as illustrated in FIG. 10.

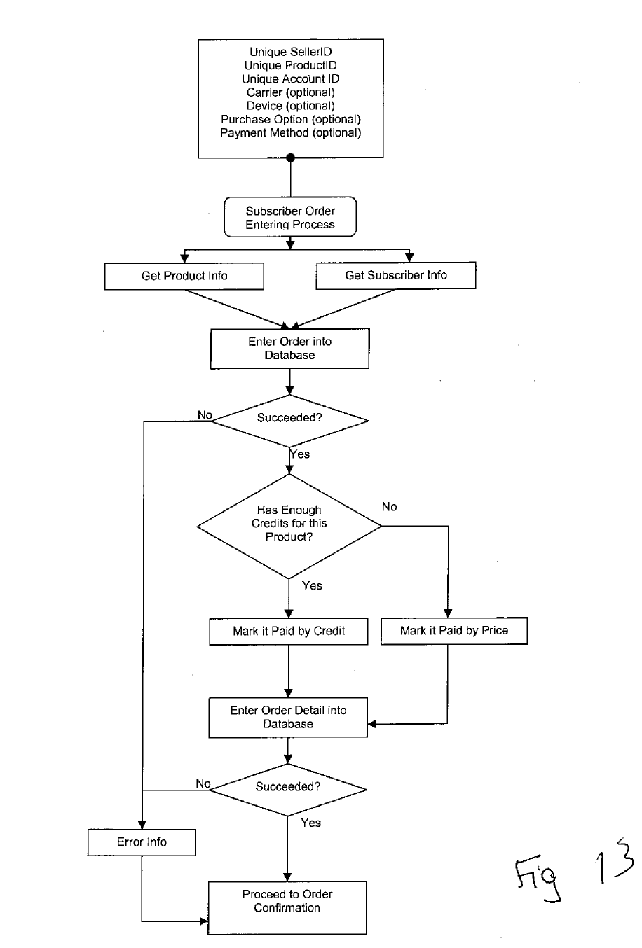

FIG. 11 is a flow chart illustrating order placing login by a buyer. A determination of subscription purchase is made. Upon this determination, a further determination whether a login is required or not is made. If a login to system is required in order to proceed to next purchase step. The system will check if the buyer has logged in or not, if the buyer has logged in already, they will be redirected to information page, otherwise the buyer is redirected to login page. The following information will be displayed on information page: account info, available credits, mobile device model, and buyer's mobile service carrier

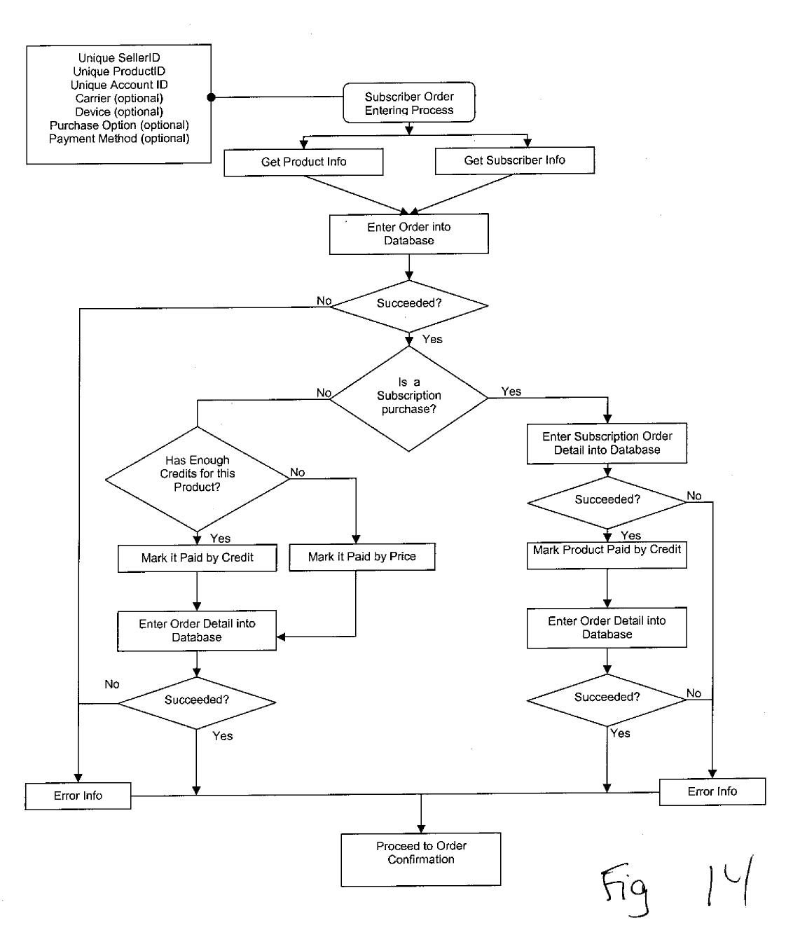

FIG. 12 is a flow chart illustrating an order entering process. A variety of information can be entered for a buyer, including but not limited to, a unique seller identifier, unique product identifier, phone number, e-mail, carrier, device, purchase option, payment method and the like. A determination is made to ascertain if there is an existing account with the buyer. If yes, then the account information is obtained. Then, a determination is made to ascertain if the buyer is a subscriber or not. If there is no account, then one is obtained in order to proceed to order confirmation.

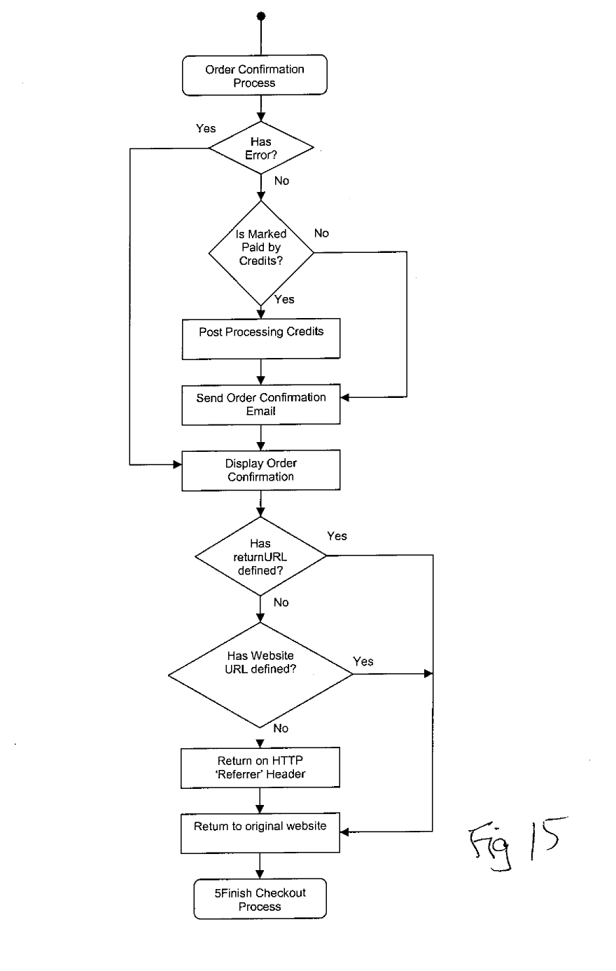

FIG. 13 is a flow chart illustrating a subscriber order entering process Here, the buyer is a subscriber. A variety of inputs can be entered for a subscriber, including by not limited to, unique seller identifier, unique product identifier, unique account identifier, carrier, device, purchase option, payment method, and the like. Product information or subscriber information is obtained and an order is entered into a database. A query is made to determine if the subscriber has enough credits for the purchase of the product. If yes, they the product is marked as being paid by credit. If not, then it is marked as paid by price. This data, the order detail, is entered into a database, and then the process proceeds to order confirmation.

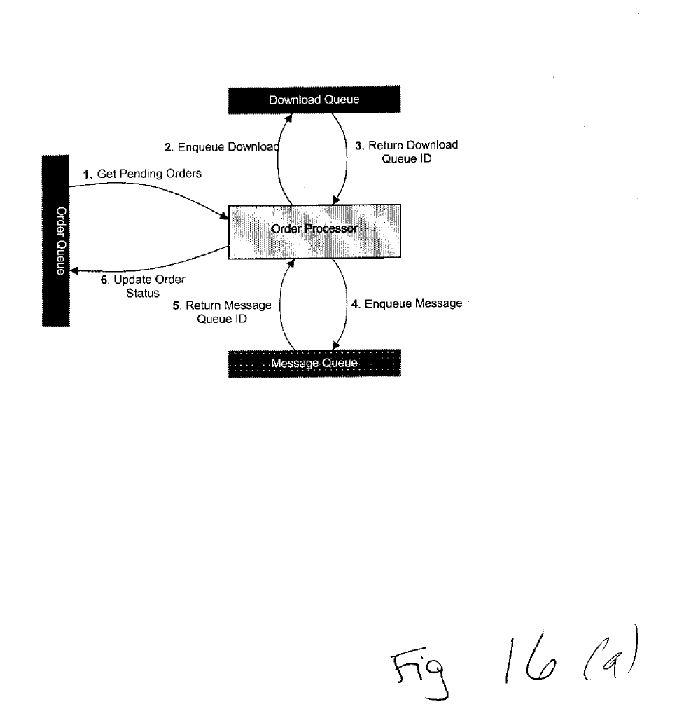

FIG. 14 is a flow chart illustrating a subscriber order entering process A variety of information can be entered into the subscriber order entering process. Product information or subscriber information is obtained, and the order is then entered into a database. A determination is made to ascertain if the purchase is a subscription purchase. The system then ascertains if there are enough credits for the purchase of the product, and proceeds to order confirmation.

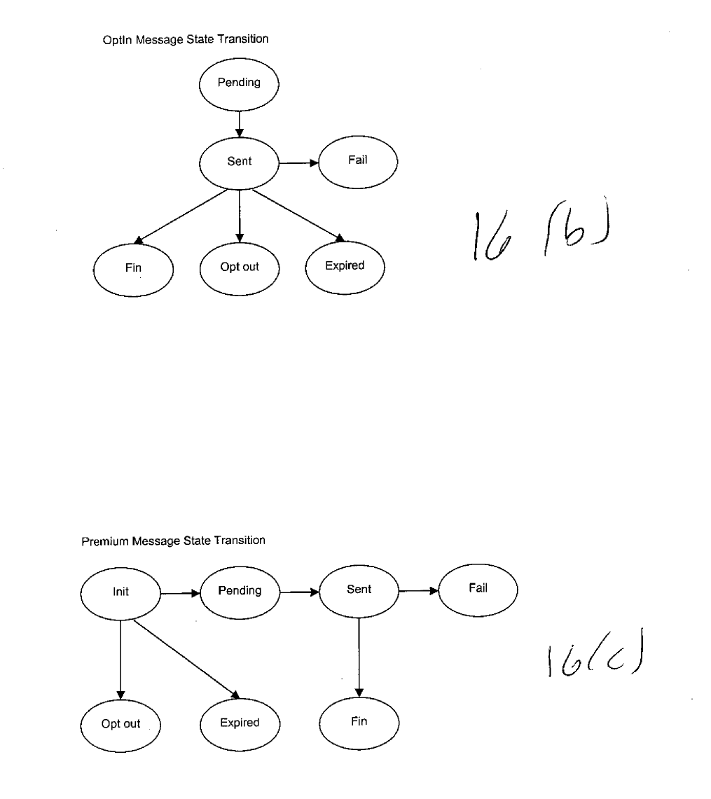

FIG. 15 is a flow chart illustrating an order confirmation process. In the order confirmation process, an error query is made before the order confirmation is displayed Queries are then made determined if there has been a return URL defined, and has a website URL be defined. A return on a HTTP referrer header is made and a return to the original website is also done, before proceeding to the finish checkout process.

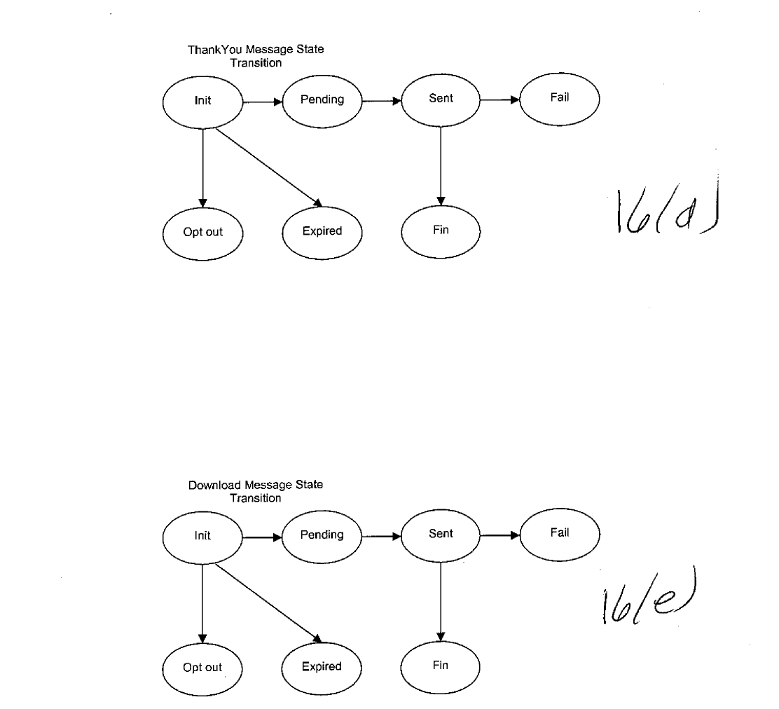

FIGS. 16(a) through 16(e) illustrate the order processing system, with different type of message. A buyer places an order in the system which enters an order in a queue process. Processing of the order is based on the type of order and is either a subscription or a la carte order. Once a determination is made as to the type of order a determination is made to ascertain if the order has content associated with the order, e.g. once a determination of subscription order type has been made, then there are two order items associated to this single order verses. there is one order item associated to a la carte order; which are: a subscription service order item, and a downloadable content order item. Since the subscription service is not downloadable via mobile device, therefore only downloadable content order item is added into download queue. A unique download queue identifier which will further be associated to message queue, is returned to order processor. Once the system obtains this unique download queue identifier, it proceeds to add messages with different types or a message with download type into message queue, and these messages or a message said above is bound to the download queue identifier which is obtained from the step above. The different types of message, not specific in the following order, can be optin, premium, thank you, download and the like, are added into message queue, and an unique message queue identifier is returned.

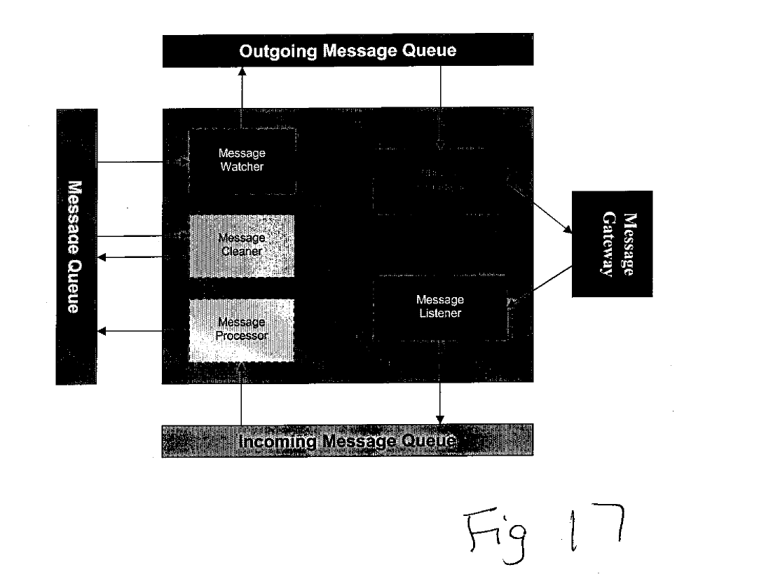

FIG. 17 illustrates one embodiment of a message system of the present invention.

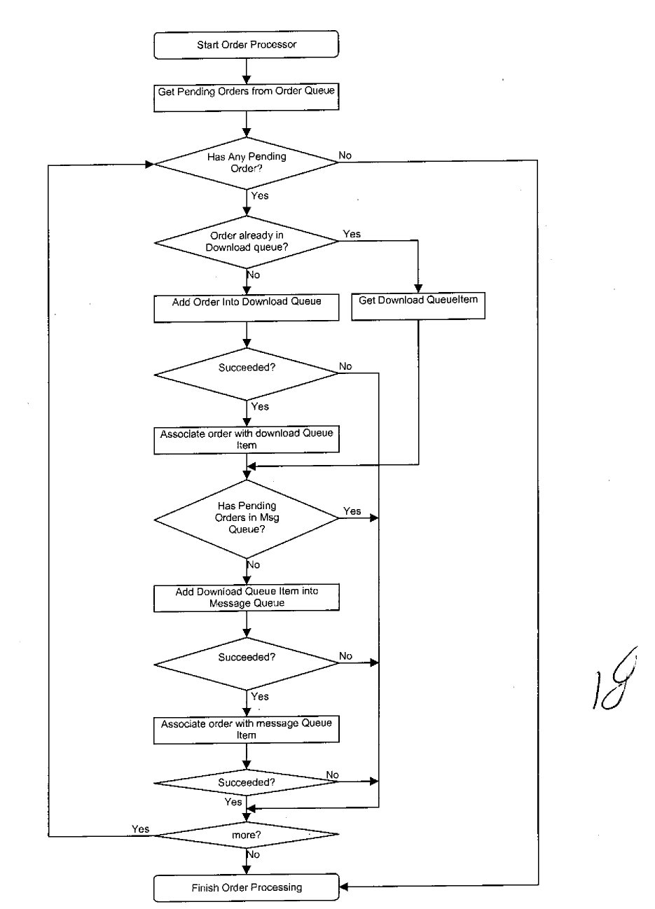

FIG. 18 is a flow chart illustrating one embodiment of order processing with the present invention. An determination is made to check whether a downloadable order item has already been queued into download queue or not; if it has already been queued, system will get the download queue identifier from the download queue; then system proceeds to check if this downloadable order item has pending message waiting to be sent in message queue, and the determination is made by checking the phone number; if it has a pending message in message queue waiting for confirmation, the order process will skip this downloadable order item, and proceeds to next order item.

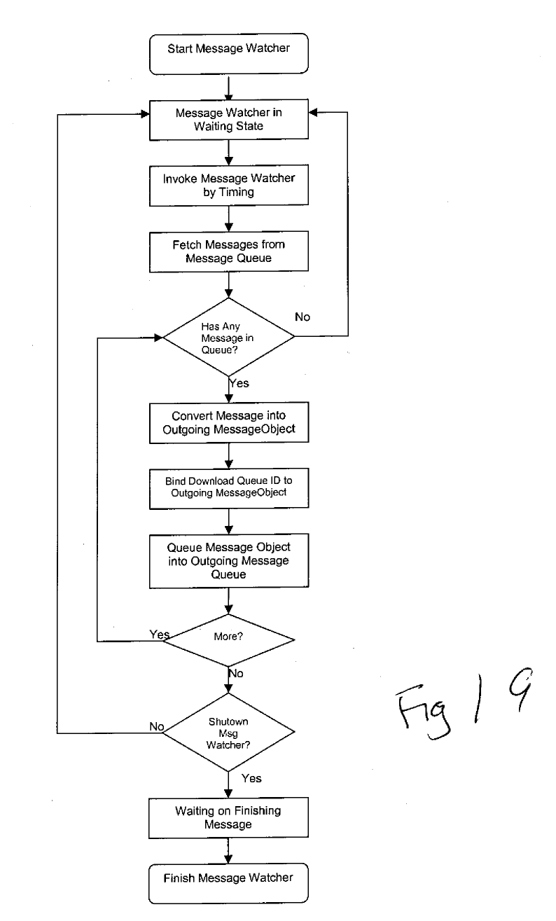

FIG. 19 is a flow chart illustrating one embodiment of a message watcher of the present invention. The message watcher starts, and is in a waiting state. The message watcher which is invoked periodically by a timer keeps watching the message queue, and then messages are retrieved from the message queue. If there are messages in the message queue then they are converted into outgoing message objects. A download queue identifier will be bound to an outgoing message object. The converted outgoing message objects are then put into an outgoing message queue. A query is made whether the message watcher is signaled to shutdown, and if so, then the message watcher will put the shutdown signal on waiting state until all the messages in message queue has been processed.

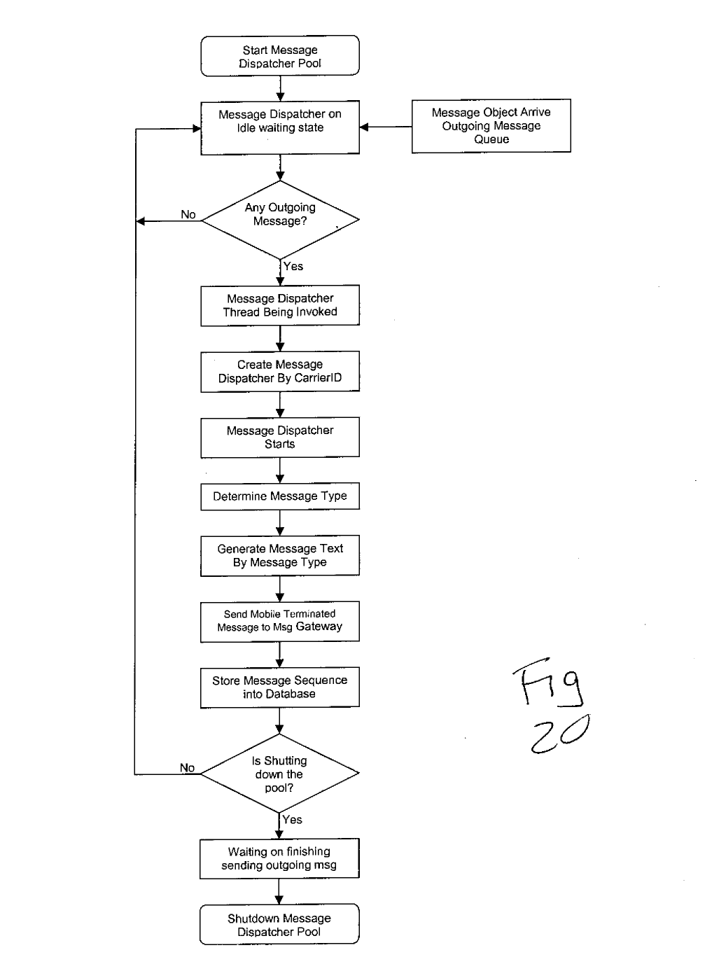

FIG. 20 is a flow chart illustrating one embodiment of a message dispatcher of the present invention. The message dispatcher pool starts and it is in an idle waiting state while keep watching outgoing message queue. If there are outgoing message objects arrived in outgoing message queue, then a message dispatcher thread from the message dispatcher pool is invoked, and a carrier identifier is associated to this message dispatcher. At the time when the message dispatcher thread starts, it determines the type of message, generates a message text by the type of message, sends a mobile terminated message to a message gateway, stores message sequences into a database and returns itself back into message dispatcher pool. The message dispatcher pool will determines if it receives a shutdown signal. If so, then the message dispatcher pool puts the shutdown signal on waiting state and waits on finishing sending outgoing messages before shutting down itself.

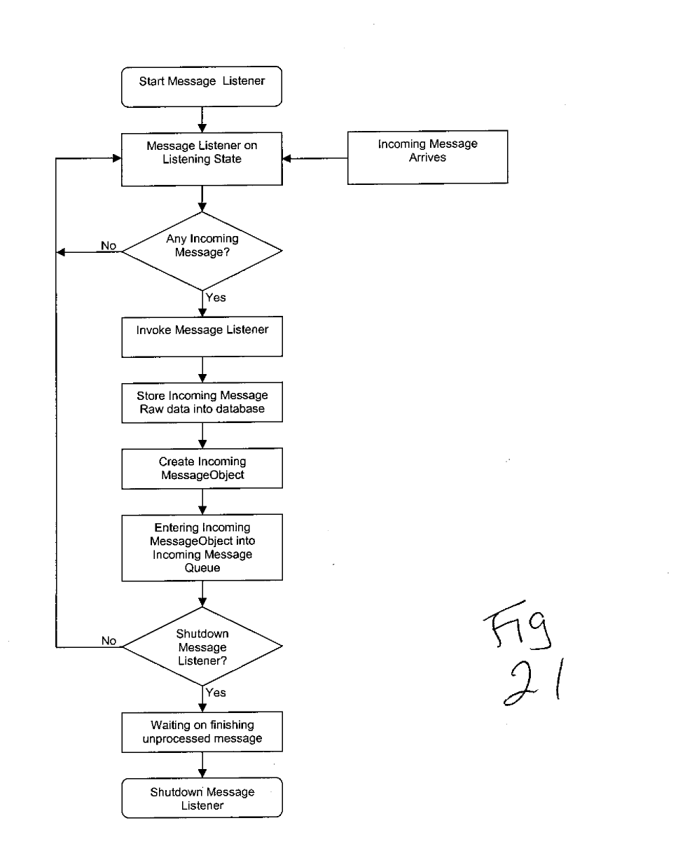

FIG. 21 is a flow chart illustrating one embodiment of a message listener of the present invention. The message listener starts in a listening state and keeps listening on the incoming message. An incoming message invokes the message listener. If there is any incoming message arrives at message listener, incoming messages are stored as raw data in a database, and incoming message objects are created with the association of the raw incoming message information and are entered in an incoming message queue. If the message listener receives a shutdown signal, it puts shutdown signal to waiting state until it finishes process all the incoming messages before it resumes shutdown process.

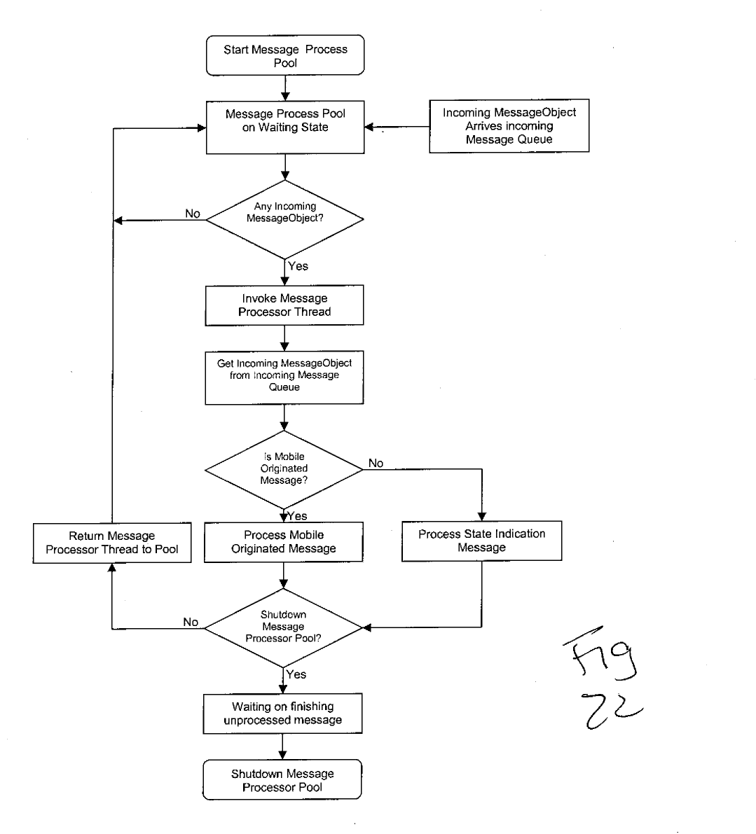

FIG. 22 is a flow chart illustrating one embodiment of a message processor of the present invention. A message process pool starts and keeps watching the incoming message queue. When any incoming message arrive in incoming message queue, a message processing thread is invoked from message process pool, and picks an incoming message object from incoming message queue. A determination of the incoming message type is made for system to decide how to proceed to handle this message. There are two types of incoming messages: mobile originated message, or state indication message. After finishing processing incoming message, the message processing thread will return itself back to message process pool. If the message process pool receives a shutdown signal, it will put the shutdown signal into waiting state until it finishes all the messages in incoming message queue before it resumes shutdown process.

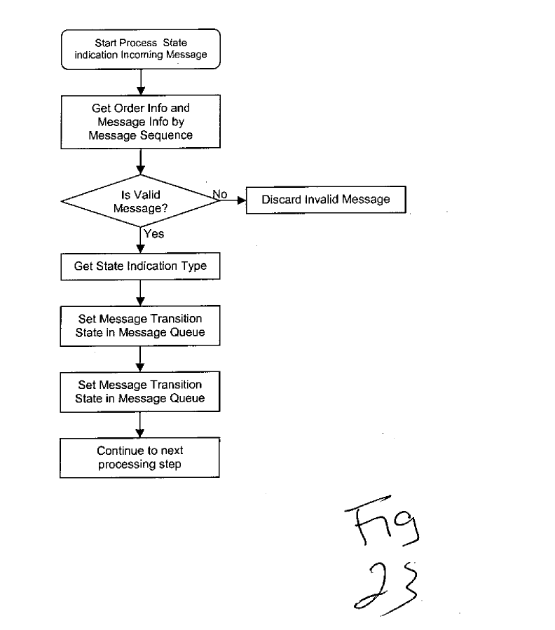

FIG. 23 is a flow chart illustrating one embodiment of a process state indication for an incoming message of the present invention. Order information and message information is obtained by the message sequence. If the message is valid then the type of state indication is obtained. The message transition state is then set in a message queue.

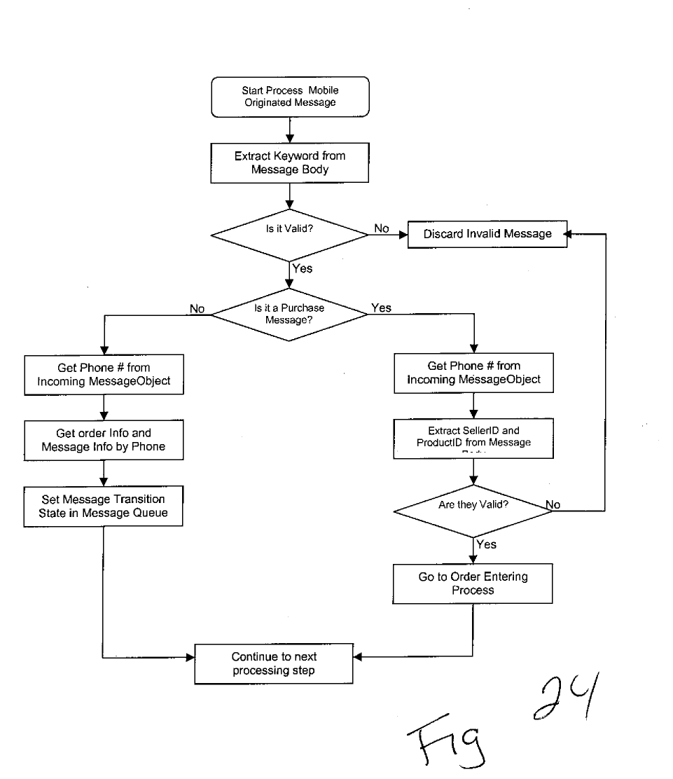

FIG. 24 is a flow chart illustrating one embodiment of the processing of a mobile originated message of the present invention. Keywords are extracted from the message body. A determination is made as to the validity of the message. If the message is valid, then a determination is made to ascertain if the message is a purchase message. If it is, the phone number is obtained from an incoming message object, the seller identifier and product identifier are extracted and determined if they are valid, and, the system proceeds to an order entering process with this message. If the message is not a purchase message, then the phone number is obtained from the incoming message object. Order information and message information is obtained by phone. A message transition state is set in the message queue.

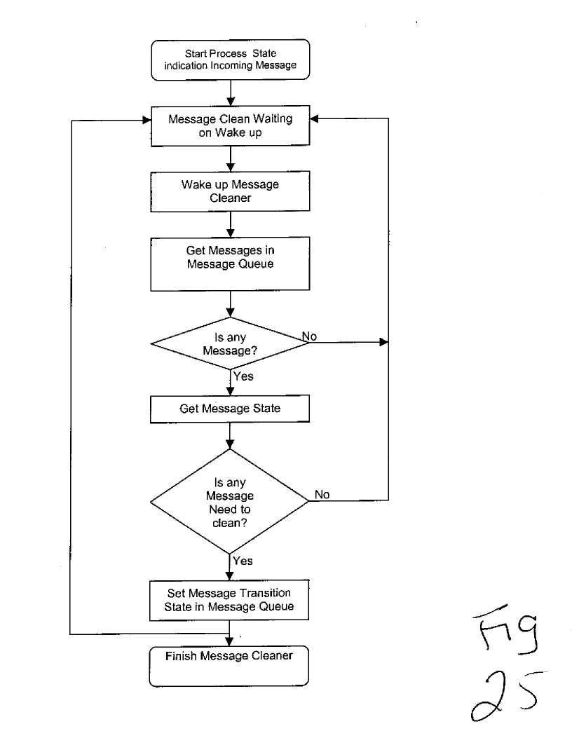

FIG. 25 is a flow chart illustrating one embodiment of a message cleaner of the present invention. The message cleaner is put in wake up mode and messages are then received from the message queue. The message state is determined. If the message requires cleaning, then the message transition state is set in the message queue and the message cleaner finishes cleaning the message.

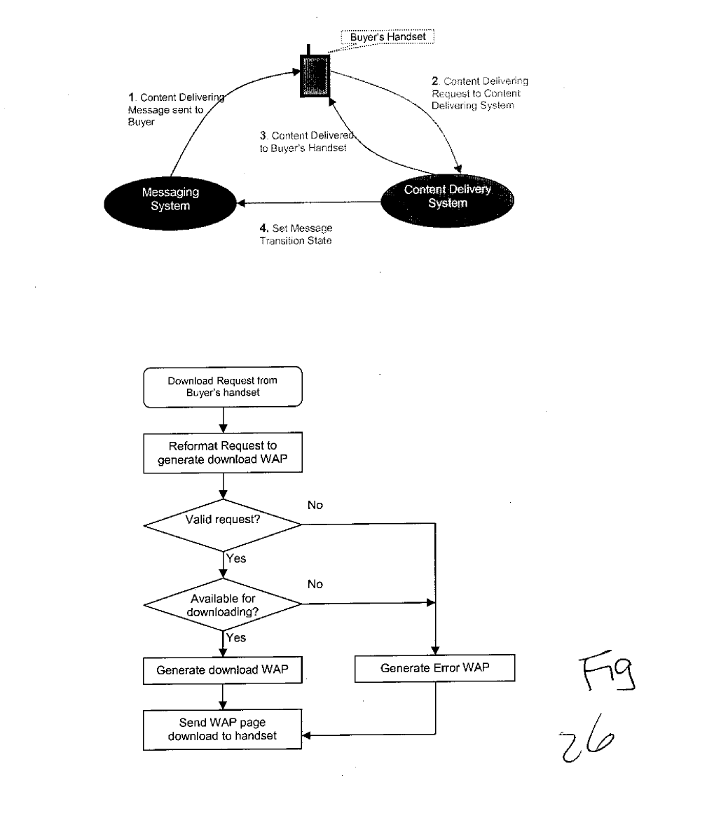

FIG. 26 is a flow chart illustrating one embodiment of a content delivery system with a buyer's mobile device of the present invention. Download request is sent from a buyer's mobile device to content delivery system. The request is reformatted to generate a download WAP document which will be sent to buyer's mobile device. If the request is valid, then a determination is made to ascertain if the content is available for downloading A download WAP document is generated, and a WAP document for downloading content is then sent to the mobile device if the content is available for downloading.

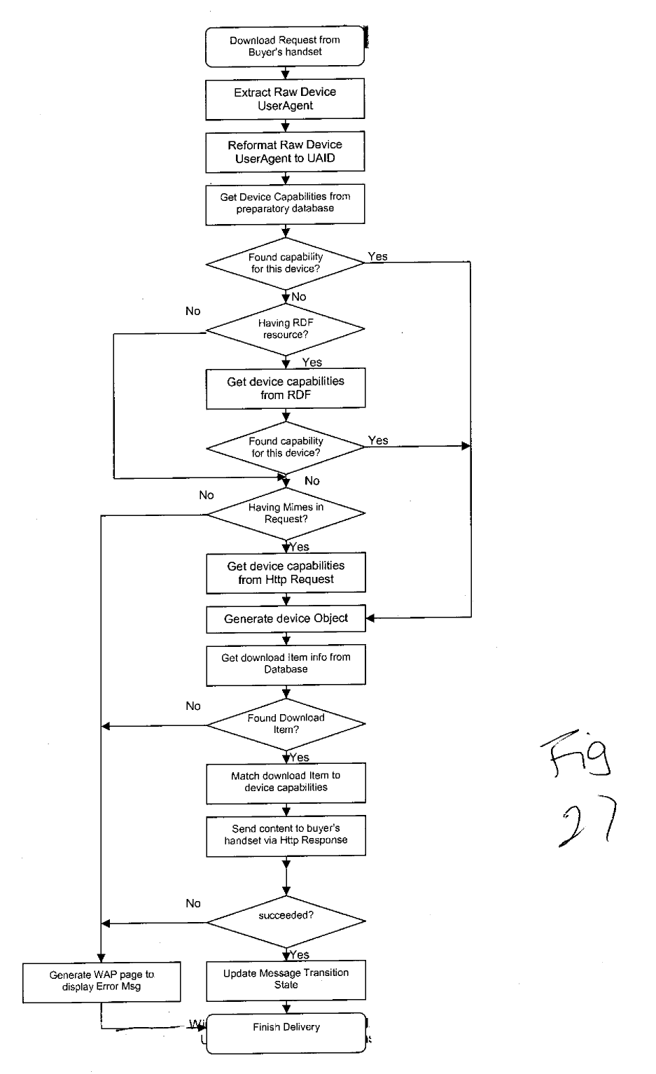

FIG. 27 is a flow chart illustrating one embodiment of a content delivery system with a buyer's mobile device of the present invention. A download request is received from a buyer's mobile device by content delivery system. Raw device user agent is extracted from the request header and reformatted. The mobile device capabilities are obtained from a database. If it is found to be capable, then a device object is generated. If not, then a determination is made to see if the mobile device has an RDF (Resource Definition Framework) resource available from request header. If yes, then the mobile device capabilities are obtained from RDF and capabilities for the device are found. Once a downloaded item is located, there is a matching of the downloaded item to the mobile device capabilities. Content is then sent to the buyer's mobile device via an HTTP response. Is this is successful, then message transition state which is associated to this download is updated, which will trigger a final mobile terminated message sent to mobile device and the delivery is then completed.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A computer based system to conduct the sale of a product or service, comprising:
a gateway system that has a database with one or more catalogs of content for products or services:
a merchant interface for a merchant that is coupled to the gateway system;
a buyer interface for a buyer that is coupled to the merchant interface and the gateway system;
wherein the gateway system hosts the purchase of products or services by a buyer in a manner such that purchase of products or services by the buyer appears as a purchase through the merchant interface and not through the gateway system.

2. The system of claim 1, wherein the buyer accesses the gateway system through the buyer interface and the merchant interface.

3. The system of claim 1, wherein the buyer accesses the gateway system through a gateway system interface.

4. The system of claim 1, wherein the gateway system is configured to provide that for a purchase of a product or service by a buyer, the buyer selects content from the one or more catalogs of content.

5. The system of claim 1, wherein the merchants enter into business relationships with the gateway system for the sale of the products and services.

6. The system of claim 1, wherein the gateway system includes a content delivery system, a checkout system and an order processing and messaging system.

7. The system of claim 1, wherein involvement of the gateway system in the purchase of products or services by the buyer is transparent to the buyer and appears as a purchase through the merchant interface.

8. The system of claim 7, wherein each of a merchant establishes an account with the gateway system.

9. The system of claim 1, wherein the gateway system is configured to enable at least a portion of the merchants to include and couple their own merchant content with the content selected from the at least one or more catalogs of content from the gateway system.

10. The system of claim 1, wherein the gateway system is configured to enable customization of a graphical user interface hosted by the gateway system.

11. The system of claim 1, wherein the gateway system is configured to enable customization of a graphical user interface hosted at the merchant interface.

12. The system of claim 1, wherein the gateway system is configured to enable a merchant to customize terms and conditions of sale for products or services through the merchant interface

13. The system of claim 1, wherein the gateway system is configured to provide that merchants can customize order confirmation e-mails through the merchant interface for products and services hosted by the gateway system.

14. The system of claim 1, wherein the buyer's interface is a mobile device, and the gateway system is configured to send SMS to the buyer's mobile device on behalf of a merchants.

15. The system of claim 1, wherein the gateway system, is configured to handle message interactions between buyers and merchants.

16. The system of claim 1, wherein the merchant interface is an html page.

17. The system of claim 1, wherein the merchant interface is a web page.

18. The system of claim 1, wherein the buyer interface is selected from at least one of, a mobile device and a computer.

19. The system of claim 18, wherein messages are sent to the gateway system through a buyer's mobile device.

20. The system of claim 1, wherein the merchant interface is a html hyperlink which can be plugged into an editable web document.

21. The system of claim 1, wherein the merchant interface is a portion of html code which can be plugged into an editable web document.

22. The system of claim 1, wherein the product or service is digital content.

23. The system of claim 1, wherein the merchant interface is editable.

24. The system of claim 1, wherein the merchant can select individual or multi pieces of the content to add to the merchant interface.

25. The system of claim 1, wherein the content is mobile content of software that runs on a mobile or handheld device.

26. The system of claim 1, wherein the content is mobile content that includes at least one of, ring tone, music, full track music, streaming music, polyphonic version of music, video games, video clips, streaming video, full video tracks, digital artwork, java based applications and BREW based applications.

27. The system of claim 1, wherein the merchant interface includes a system administration interface configured to perform at least one of, configure gateway user interface, view reports, select an individual product to merchandise or select a catalog of content to merchandise, select product meta-data to display selected from at least one of, descriptions, reviews and screen shots, select product billing options, select billing methods and configure its administrative capabilities within its account.

28. The system of claim 1, wherein the merchant interface is configured to provide for customization of a hosted check out or of an order confirmation page.

29. The system of claim 1, wherein the merchant interface includes a hosted check out page.

30. The system of claim 1, wherein the gateway system is configured to provide at least one of, a check out page and order confirmation page that is customizable by a merchant.

31. The system of claim 1, wherein the gateway system is configured to permit a merchant to customize at least one of, header and footer, terms and conditions of sale, advertisements, web page color, web page design, web page display, web page background color, web page font size and web page background image and multi-media on a web page.

32. The system of claim 1, wherein the gateway system is configured to provide billing integration.

33. The system of claim 1, wherein the gateway system is configured to provide the buyer with SMS notification for content downloads.

34. The system of claim 1, wherein the gateway system is configured to receive a buyer's order for the product or service.

35. The system of claim 1, wherein the gateway system has a buyer checkout page.

36. The system of claim 1, wherein the content includes at least one of, product identification number, product name, product producer, product vendor, identification number, product cost, product size (in bits of data) and product digital file format.

37. The system of claim 1, wherein the gateway system is configured to determine whether to display carrier and device selection in response to inputs by the buyer.

38. The system of claim 1, wherein the gateway system automatically determines a buyer's carrier.

39. The system of claim 1, wherein the gateway system is configured to display product or product selection.

40. The system of claim 1, wherein the gateway system is configured to validate selected buyer inputs.

41. The system of claim 1, wherein the gateway system is configured to permit buyer inputs selected from at least one of, buyer mobile device number, buyer mobile device make, buyer mobile device model, buyer mobile device wireless carrier, buyer email, buyer acceptance of terms and conditions, buyer choice of purchase price and buyer choice of product purchase.
